(19) United States
(12) Patent Application Publication
(10) Pub. No.: US 2012/0104094 A1
(43) Pub. Date: May 3, 2012

(54) PROXIMITY INTEGRATED CIRCUIT CARD READER

(75) Inventors: Ephraim CHROLOVICH, Netanya (IL); Oren NAVON, Ganei Tikva (IL)

(73) Assignee: VERIFONE, INC., San Jose, CA (US)

(21) Appl. No.: 12/917,026

(22) Filed: Nov. 1, 2010

(51) Int. Cl. G06K 7/10; H04Q 5/22

(52) U.S. Cl. 235/380; 235/439; 340/10.1

(57) ABSTRACT

A proximity integrated circuit card reader including a transmitter, transmitting energy within a proximity integrated circuit card reading volume, a receiver, receiving a signal from a proximity integrated circuit card located within the proximity integrated circuit card reading volume and a controller operative in a card presence sensing mode for sensing, but not reading, a card located within the proximity integrated circuit card reading volume and, responsive to sensed probable card presence, operative in a card reading mode for reading a card located within the proximity integrated circuit card reading volume.

### REFERENCE TO RELATED APPLICATIONS

The following patent application is believed to be related to the present application, the disclosure of which is hereby incorporated by reference:

U.S. Published Patent Application No. 2009/0237214.

### FIELD OF THE INVENTION

The present invention relates to card readers generally and more particularly to proximity integrated circuit card readers and to devices which include proximity integrated circuit card readers.

### BACKGROUND OF THE INVENTION

The following publication is believed to represent the current state of the art:

U.S. Published Patent Application No. 2009/0237214.

### SUMMARY OF THE INVENTION

The present invention seeks to provide improved card readers for proximity integrated circuit cards, which are also known as contactless smart cards.

There is thus provided in accordance with a preferred embodiment of the present invention a proximity integrated circuit card reader including a transmitter, transmitting energy within a proximity integrated circuit card reading volume, a receiver, receiving a signal from a proximity integrated circuit card located within the proximity integrated circuit card reading volume and a controller operative in a card presence sensing mode for sensing, but not reading, a card located within the proximity integrated circuit card reading volume and, responsive to sensed probable card presence, operative in a card reading mode for reading a card located within the proximity integrated circuit card reading volume.

There is also provided in accordance with another preferred embodiment of the present invention a point of sale terminal including proximity integrated circuit card reader functionality and including a transmitter, transmitting energy within a proximity integrated circuit card reading volume, a receiver, receiving a signal from a proximity integrated circuit card located within the proximity integrated circuit card reading volume and a controller operative in a card presence sensing mode for sensing, but not reading, a card located within the proximity integrated circuit card reading volume and, responsive to sensed probable card presence, operative in a card reading mode for reading a card located within the proximity integrated circuit card reading volume.

Preferably, the controller is operative in the card presence sensing mode for causing the transmitter to transmit energy with a first pulse width and a first power level and is operative in the card reading mode for causing the transmitter to transmit energy with a second pulse width and a second power level, the second pulse width being greater than the first pulse width and the second power level being higher than the first power level.

In accordance with a preferred embodiment of the present invention the controller is operative in the card presence sensing mode for causing the transmitter to transmit energy with a first pulse width and is operative in the card reading mode for causing the transmitter to transmit energy with a second pulse width, the second pulse width being higher than the first pulse width.

Preferably, the controller is operative in the card presence sensing mode for causing the transmitter to transmit energy at a first power level and is operative in the card reading mode for causing the transmitter to transmit energy at a second power level, the second power level being higher than the first power level.

In accordance with a preferred embodiment of the present invention the first power level is insufficient for reading a proximity integrated circuit card. Additionally or alternatively, the first pulse width is insufficient for reading a proximity integrated circuit card.

Preferably, the controller is operative in the card presence sensing mode for causing the transmitter to transmit energy continuously.

In accordance with a preferred embodiment of the present invention the controller is operative in the card presence sensing mode in response to a trigger.

### BRIEF DESCRIPTION OF THE DRAWINGS

The present invention will be understood and appreciated more fully from the following detailed description, taken in conjunction with the drawings in which:

FIG. 1 is a simplified illustration of the operation of a point of sale device incorporating a proximity integrated circuit card reader, constructed and operative in accordance with a preferred embodiment of the present invention;

FIG. 2 is a simplified illustration of the operation of a point of sale device incorporating a proximity integrated circuit card reader, constructed and operative in accordance with another preferred embodiment of the present invention;

FIG. 3 is a simplified illustration of the operation of a point of sale device incorporating a proximity integrated circuit card reader, constructed and operative in accordance with yet another preferred embodiment of the present invention;

FIG. 4 is a simplified illustration of one embodiment of proximity integrated circuit card reader control circuitry useful in the embodiments of FIGS. 1-3; and

FIG. 5 is another simplified illustration of another embodiment of proximity integrated circuit card reader control circuitry useful in the embodiments of FIG. 1 and FIG. 3.

### DETAILED DESCRIPTION OF PREFERRED EMBODIMENTS

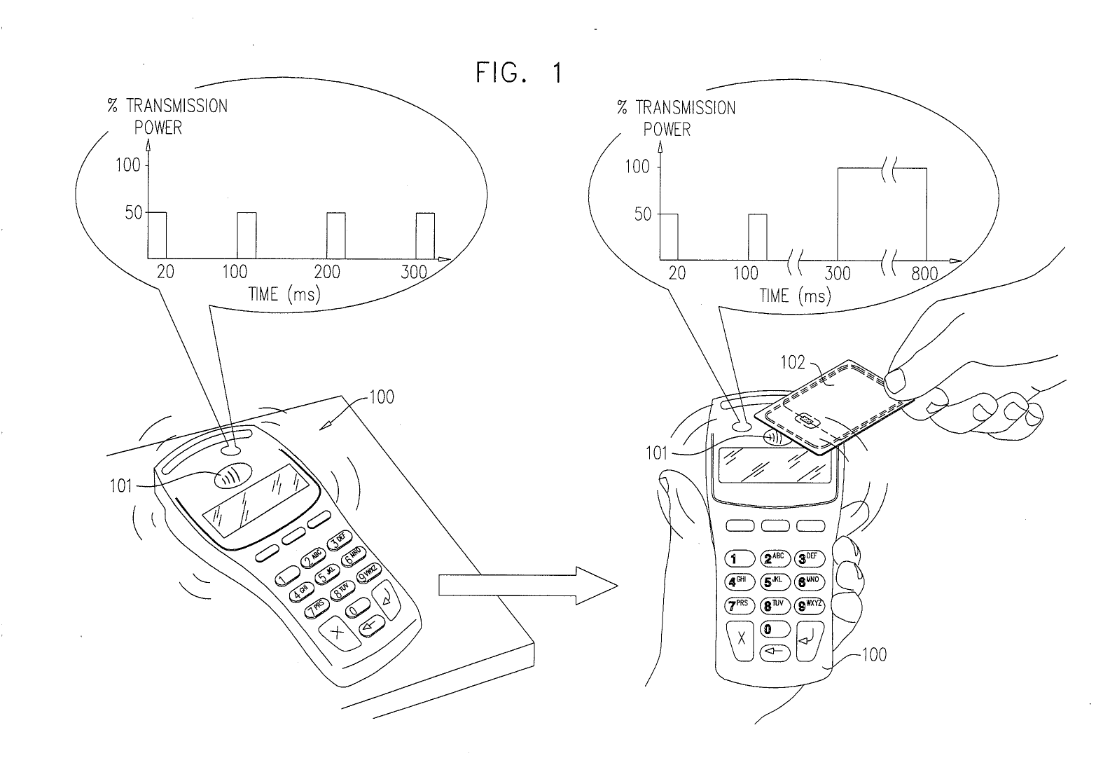

Reference is now made to FIG. 1, which is a simplified illustration of the operation of a point of sale device incorporating a proximity integrated circuit card reader, constructed and operative in accordance with a preferred embodiment of the present invention. The invention may be advantageously embodied in a POS device, such as a model VX520, commercially available from Verifone Inc. As seen in FIG. 1, there is provided a proximity integrated circuit card reader 100 which, upon receipt of a trigger input, typically transmits a pulsed signal in the vicinity of the reader, typically within a distance of approximately 3-4 cm from the center of the tapping icon 101 located on the card reader 100, as specified in EMV Contactless Communication Protocol Specification—Contactless Specifications for Payment Systems Version 2.0.1, July, 2009, paragraph C.2.4 (Center of Contactless Symbol).

The pulsed signal typically has a relatively low power level of approximately one Watt, typically one-half of the power required for reading of a proximity integrated circuit card, but sufficient for detection of the probable presence of a proximity integrated circuit card, and a pulse width of 20 ms. The pulses are typically transmitted with a periodicity of 100 ms.

It is appreciated that while a pulse width of 20 ms is generally insufficient for reading card data in a financial transaction, it is sufficient to detect an input, such as would be generated by the presence of a proximity integrated circuit card. Typically, a pulse width of 100-500 ms is required for reading card data in a financial transaction.

In accordance with a preferred embodiment of the present invention, the proximity integrated circuit card reader 100 senses the presence of a suitable proximity integrated circuit card, here designated by reference numeral 102, in real time or near real time and, responsive to the presence of the proximity integrated circuit card 102, increases the power level of the transmitted pulse to a level, typically two Watts, sufficient for reading of the proximity integrated circuit card, and increases the pulse width to a pulse width sufficient for reading card 102, typically 500 ms.

The trigger input may be provided automatically by a payment system which prompts a customer to present his proximity integrated circuit card or may be provided manually by an operator, such as a sales clerk, or may be provided automatically by a timing mechanism. As a further alternative, the card reader may transmit pulses without requiring a trigger input. Normally, when a trigger input is provided, the transmission of pulses continues for a predetermined time duration, typically five seconds.

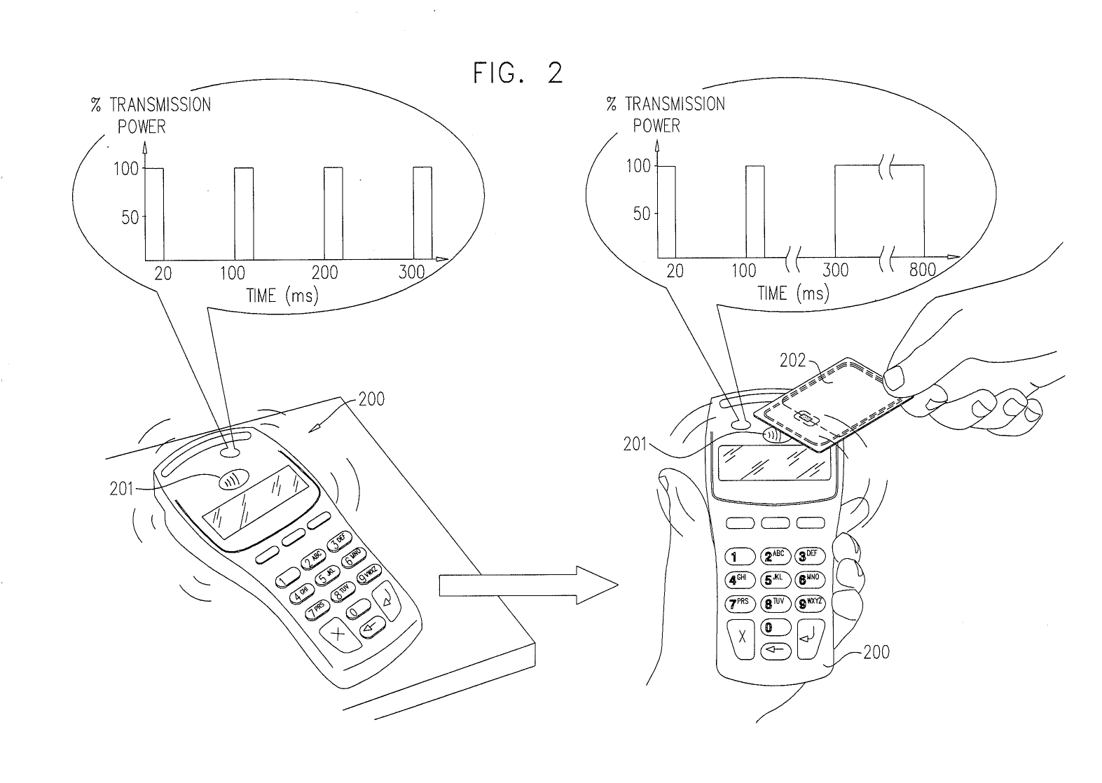

Reference is now made to FIG. 2, which is a simplified illustration of the operation of a point of sale device incorporating a proximity integrated circuit card reader, constructed and operative in accordance with a preferred embodiment of the present invention. The invention may be advantageously embodied in a POS device, such as a model VX520, commercially available from Verifone Inc. As seen in FIG. 2, there is provided a proximity integrated circuit card reader 200 which, upon receipt of a trigger input, typically transmits a pulsed signal in the vicinity of the reader, typically within a distance of approximately 3-4 cm from the center of the tapping icon 201 located on the card reader 200, at a power level, typically approximately two Watts, sufficient for reading of a proximity integrated circuit card, and a pulse width of 20 ms. The pulses are typically transmitted with a periodicity of 100 ms.

It is appreciated that while a pulse width of 20 ms is generally insufficient for reading card data in a financial transaction, it is sufficient to detect an input, such as would be generated by the presence of a proximity integrated circuit card. Typically, a pulse width of 100-500 ms is required for reading card data in a financial transaction.

In accordance with a preferred embodiment of the present invention, the proximity integrated circuit card reader 200 senses the presence of a suitable proximity integrated circuit card, here designated by reference numeral 202, in real time or near real time and, responsive to the presence of the proximity integrated circuit card 202, increases the pulse width to a pulse width sufficient for reading card 202, typically 500 ms.

The trigger input may be provided automatically by a payment system which prompts a customer to present his proximity integrated circuit card or may be provided manually by an operator, such as a sales clerk, or may be provided automatically by a timing mechanism. As a further alternative, the card reader may transmit pulses without requiring a trigger input. Normally, when a trigger input is provided, the transmission of pulses continues for a predetermined time duration, typically five seconds.

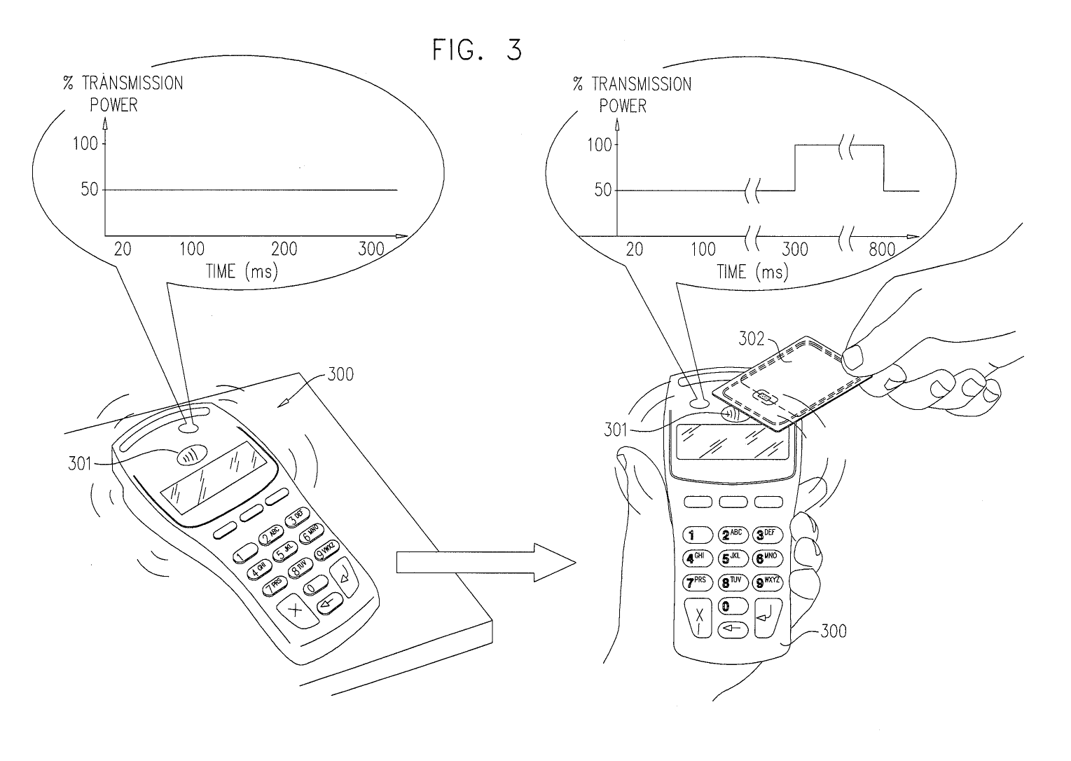

Reference is now made to FIG. 3, which is a simplified illustration of the operation of a point of sale device incorporating a proximity integrated circuit card reader, constructed and operative in accordance with a preferred embodiment of the present invention. The invention may be advantageously embodied in a POS device, such as a model VX520, commercially available from Verifone Inc. As seen in FIG. 3, there is provided a proximity integrated circuit card reader 300 which, upon receipt of a trigger input, typically transmits a signal in the vicinity of the reader, typically within a distance of approximately 3-4 cm from the center of the tapping icon 301 located on the card reader 300, at a power level, typically one Watt, insufficient for reading of a proximity integrated circuit card, but sufficient for detection of the probable presence of a proximity integrated circuit card.

In accordance with a preferred embodiment of the present invention, the proximity integrated circuit card reader 300 senses the presence of a suitable proximity integrated circuit card, here designated by reference numeral 302, in real time or near real time and, responsive to the presence of the proximity integrated circuit card 302, increases the power level of the transmitted pulse to a level sufficient for reading of the proximity integrated circuit card, typically two Watts.

The trigger input may be provided automatically by a payment system which prompts a customer to present his proximity integrated circuit card or may be provided manually by an operator, such as a sales clerk, or may be provided automatically by a timing mechanism. As a further alternative, the card reader may transmit the signal without requiring a trigger input. Normally, when a trigger input is provided, the signal transmission continues for a predetermined time duration, typically five seconds.

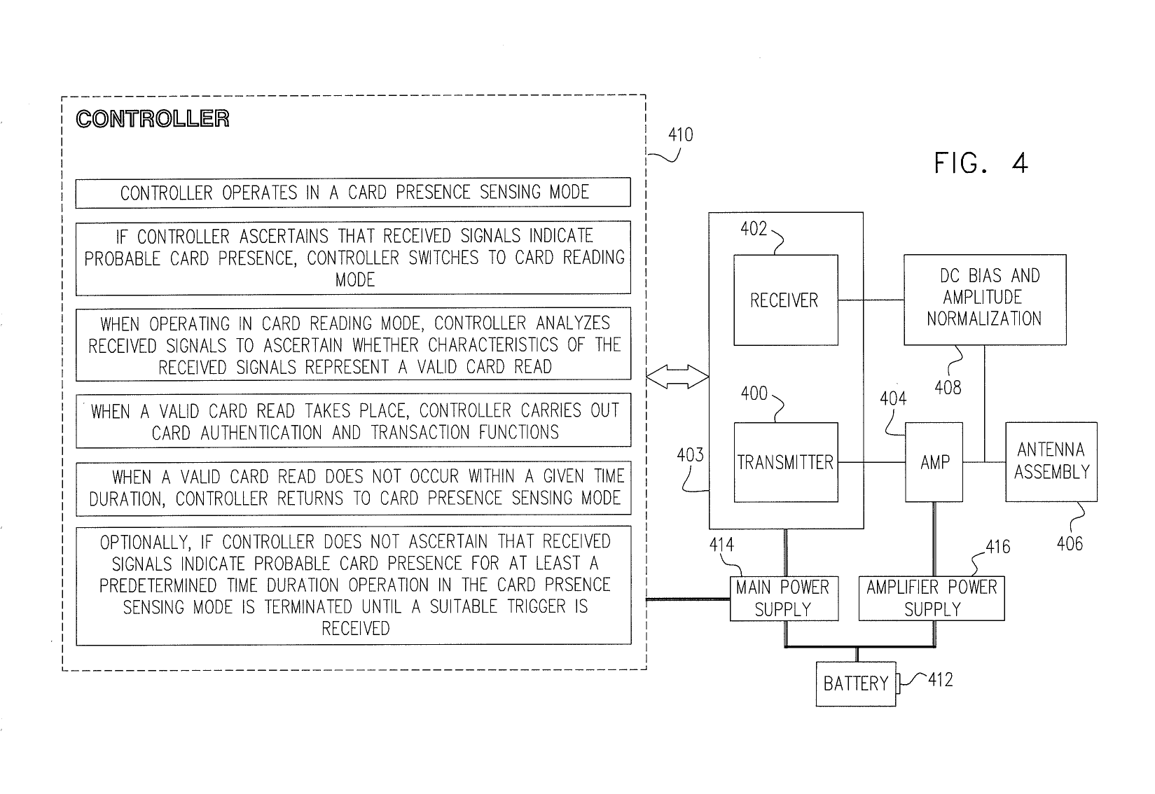

Reference is now made to FIG. 4, which is a simplified illustration of one embodiment of proximity integrated circuit card reader control circuitry useful in the embodiment of FIG. 1. As seen in FIG. 4, the proximity integrated circuit card reader circuitry includes a transmitter 400, transmitting energy within a proximity integrated circuit card reading volume, typically within a radius of 3-4 cm of the center of the tapping icon 101 (FIG. 1) located on the card reader 100 (FIG. 1), and a receiver 402, receiving a signal from a proximity integrated circuit card 102 (FIG. 1) located within the proximity integrated circuit card reading volume. Transmitter 400 and receiver 402 are preferably together embodied in a transceiver chip 403, such as a PN5120A0HN/C1 commercially available from NXP Semiconductors. Transmitter 400 outputs via an amplifier 404, such as a push-pull amplifier or a Darlington amplifier having associated EMC filter circuitry, to an antenna assembly 406, preferably a double loop antenna having associated tuning circuitry. Receiver 402 receives signals from antenna assembly 406 via DC bias setting and amplitude normalization circuitry 408, which is operative to limit the maximum voltage level in the receiver path to a voltage level which prevents possible damage to the IC receiver.

A controller 410 is operative to operate the transmitter 400 to transmit, via antenna assembly 406, sufficient power within the proximity integrated circuit card reading volume for a sufficient time to enable probable presence of a proximity integrated circuit card within the reading volume to be detected by means of signals transmitted by the card and received by receiver 402 via antenna assembly 406. At this stage, the power level and/or the time is normally not sufficient for reading of the proximity integrated circuit card.

Upon detection of the probable presence of a proximity integrated circuit card within the reading volume, the controller 410 operates the transmitter 400 to transmit power via antenna assembly 406 within the proximity integrated circuit card reading volume at a power amplitude and for a duration which is sufficient for reading of the proximity integrated circuit card.

In accordance with a preferred embodiment of the present invention, when embodied in a proximity integrated circuit card reader 100 of the type described hereinabove with reference to FIG. 1, controller 410 has the following functionality:

In response to operator actuation, automatic user prompting, the operation of timing circuitry or in a free-running manner, controller 410 operates in a card presence sensing mode and causes transmitter 400 to transmit a pulsed signal at a relatively low power level, typically one Watt, which is about one-half of the power required for reading of a proximity integrated circuit card, but sufficient for detection of the probable presence of a proximity integrated circuit card, and a pulse width of 20 ms. The pulses are typically transmitted with a periodicity of 100 ms.

It is appreciated that while a pulse width of 20 ms is generally insufficient for reading card data in a financial transaction, it is sufficient to detect an input, such as would be generated by the presence of a proximity integrated circuit card. Typically, a pulse width of 100-500 ms is required for reading card data in a financial transaction.

Receiver 402 receives signals from the proximity integrated circuit card reading volume and controller 410 analyzes the received signals to ascertain whether the characteristics of the signals indicate that they are probably transmitted by a proximity integrated circuit card located within the proximity integrated circuit card reading volume.

If controller 410 ascertains that the received signals are probably transmitted by a proximity integrated circuit card located within the proximity integrated circuit card reading volume, it switches to a card reading mode and changes the power level and pulse width of the pulsed signal transmitted by the transmitter 400 to a level sufficient for reading of a proximity integrated circuit card located within the proximity integrated circuit card reading volume.

When the controller 410 is operating in a card reading mode, the controller 410 analyzes the signals received via antenna assembly 406 and receiver 402 to ascertain whether the characteristics of the signals represent a valid card read. If so, the controller 410 proceeds to carry out card authentication and transaction functions, which may be entirely conventional.

When the controller 410 is operating in the card reading mode, if controller 410 does not ascertain that the signals received via antenna assembly 406 and receiver 402 represent a valid card read, the controller 410 reverts, after a predetermined time duration, typically 30-40 ms, to the card presence sensing mode or, alternatively, to a sleep mode in which no signals are transmitted pending receipt of a trigger.

If controller 410 does not ascertain that received signals are probably transmitted by a proximity integrated circuit card located within the proximity integrated circuit card reading volume for at least a predetermined time duration following the trigger, typically 2 minutes, operation in the card presence sensing mode is terminated and transmission of signals is typically stopped and the controller remains in the sleep mode until a further trigger is received.

The controller 410 and the amplifier 404 are preferably powered by a battery 412 via a main power supply 414 and an amplifier power supply 416, which may output different voltage levels to accommodate controller 410 and amplifier 404 working voltage levels. Battery 412 may power the remaining circuit elements shown in FIG. 4.

The functionality of the controller 410 described above provides significant savings in battery power consumption. It is appreciated that this functionality described above is also readily applicable to the embodiments of FIGS. 2 and 3.

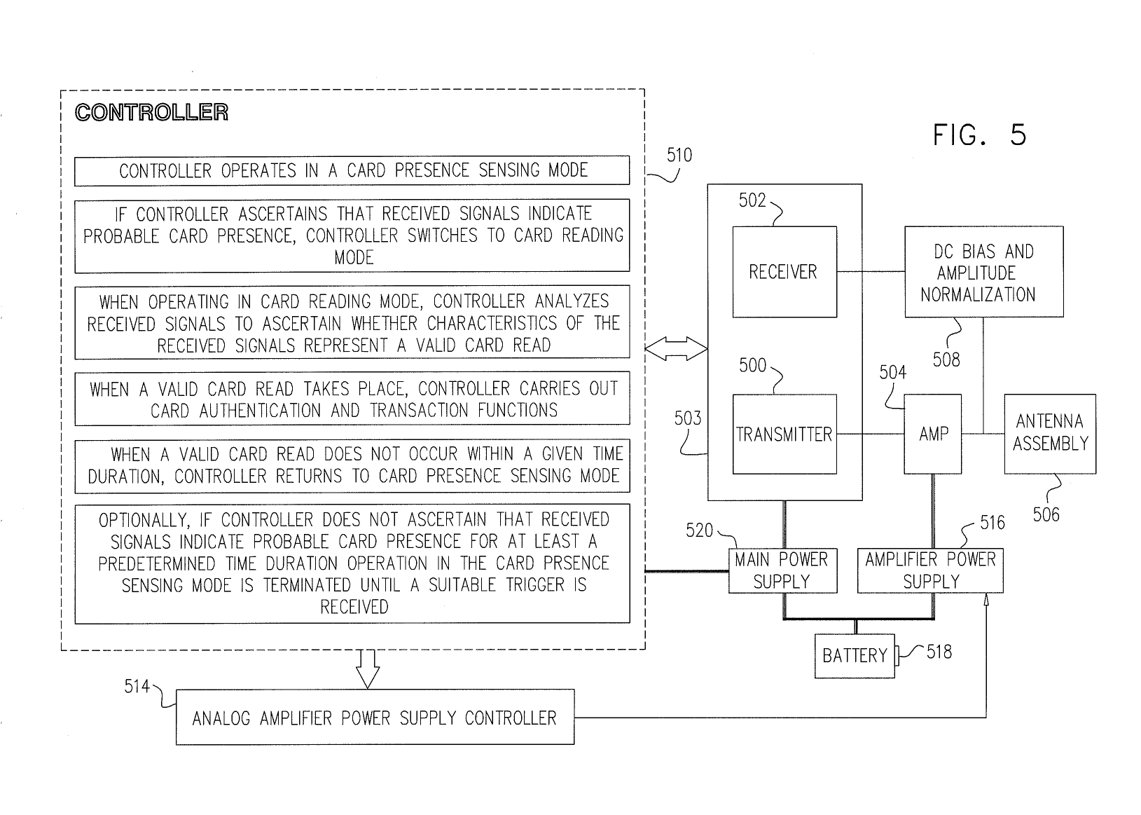

Reference is now made to FIG. 5, which is a simplified illustration of proximity integrated circuit card reader control circuitry useful in an alternative embodiment of FIG. 1. As seen in FIG. 5, the proximity integrated circuit card reader circuitry includes a transmitter 500, transmitting energy within a proximity integrated circuit card reading volume, typically within a distance of 3-4 cm from the center of the tapping icon 101 (FIG. 1) located on the card reader 100 (FIG. 1), and a receiver 502, receiving a signal from a proximity integrated circuit card 102 (FIG. 1) located within the proximity integrated circuit card reading volume.

Transmitter 500 and receiver 502 are preferably together embodied in a transceiver chip 503, such as a PN5120A0HN/C1 commercially available from NXP Semiconductors. Transmitter 500 outputs via an amplifier 504, such as a push-pull amplifier or a Darlington amplifier having associated EMC filter circuitry, to an antenna assembly 506, preferably a double loop antenna having associated tuning circuitry. Receiver 502 receives signals from antenna assembly 506 via DC bias setting and amplitude normalization circuitry 508.

A controller 510 is operative to operate an analog amplifier power supply controller 514 to command an amplifier power supply 516 to feed the amplifier circuitry 504 to transmit, via antenna assembly 506, sufficient power within the proximity integrated circuit card reading volume for a sufficient time to enable probable presence of a proximity integrated circuit card within the reading volume to be detected by means of signals transmitted by the card and received by receiver 502 via antenna assembly 506. At this stage, the power level and/or the time is normally not sufficient for reading of the proximity integrated circuit card.

The controller 510 and the amplifier 504 are preferably powered by a battery 518 via a main supply 520 and amplifier power supply 516, which may output different voltage levels to accommodate the amplifier 504 working voltage level. Main power supply 520 may power the remaining circuit elements shown in FIG. 5. The functionality of the controller 510 described below provides significant savings in battery power consumption.

Upon detection of the probable presence of a proximity integrated circuit card within the reading volume, the controller 510 is operative to operate the analog amplifier power supply controller 514 to command amplifier power supply 516 to feed the amplifier circuitry 504 to transmit, via the antenna assembly 506, sufficient power within the proximity integrated circuit card reading volume for a duration which is sufficient for reading of the proximity integrated circuit card.

In accordance with an alternative embodiment of the present invention, when embodied in a proximity integrated circuit card reader 100 of the type described hereinabove with reference to FIG. 1, controller 510 has the following functionality:

In response to operator actuation, automatic user prompting, the operation of timing circuitry or in a free-running manner, controller 510 operates in a card presence sensing mode and causes analog amplifier power supply controller 514 to command amplifier power supply 516 to supply power at a relatively low voltage level and causes transmitter 500 to transmit a pulsed signal, which is sufficient for detection of the probable presence of a proximity integrated circuit card, but insufficient for reading of a proximity integrated circuit card. The pulse width is typically 20 ms. The pulses are typically transmitted with a periodicity of 100 ms.

It is appreciated that while a pulse width of 20 ms is generally insufficient for reading card data in a financial transaction, it is sufficient to detect an input, such as would be generated by the presence of a proximity integrated circuit card. Typically, a pulse width of 100-500 ms is required for reading card data in a financial transaction.

Receiver 502 receives signals from the proximity integrated circuit card reading volume and controller 510 analyzes the received signals to ascertain whether the characteristics of the signals indicate that they are probably transmitted by a proximity integrated circuit card located within the proximity integrated circuit card reading volume.

If controller 510 ascertains that the received signals are probably transmitted by a proximity integrated circuit card located within the proximity integrated circuit card reading volume, it switches to a card reading mode and commands analog amplifier power supply controller 514 to control amplifier power supply 516 to change the power level and the pulsed signal transmitted by the transmitter 500 to a level sufficient for reading of a proximity integrated circuit card located within the proximity integrated circuit card reading volume.

When the controller 510 is operating in a card reading mode, the controller 510 analyzes the signals received via antenna assembly 506 and receiver 502 to ascertain whether the characteristics of the signals represent a valid card read. If so, the controller 510 proceeds to carry out card authentication and transaction functions, which may be entirely conventional.

When the controller 510 is operating in the card reading mode, if controller 510 does not ascertain that the signals received via antenna assembly 506 and receiver 502 represent a valid card read, the controller 510 reverts, after a predetermined time duration, typically 30-40 ms, to the card presence sensing mode or, alternatively, to a sleep mode in which no signals are transmitted pending receipt of a trigger.

If controller 510 does not ascertain that received signals are probably transmitted by a proximity integrated circuit card located within the proximity integrated circuit card reading volume for at least a predetermined time duration following the trigger, typically 2 minutes, operation in the card presence sensing mode is terminated and transmission of signals is typically stopped and the controller remains in the sleep mode until a further trigger is received.

The functionality of the controller 510 described above provides significant savings in battery power consumption. It is appreciated that this functionality described above is also readily applicable to the embodiment of FIG. 3.

It is also appreciated that the transmission power level used in the card presence sensing mode and in the card reading mode may vary by any ratio and is not limited to 50%.

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1. A proximity integrated circuit card reader comprising:
a transmitter, transmitting energy within a proximity integrated circuit card reading volume;
a receiver, receiving a signal from a proximity integrated circuit card located within said proximity integrated circuit card reading volume; and
a controller operative in a card presence sensing mode for sensing, but not reading, a card located within said proximity integrated circuit card reading volume and, responsive to sensed probable card presence, operative in a card reading mode for reading a card located within said proximity integrated circuit card reading volume.

2. A proximity integrated circuit card reader according to claim 1 and wherein said controller is operative in said card presence sensing mode for causing said transmitter to transmit energy with a first pulse width and a first power level and is operative in said card reading mode for causing said transmitter to transmit energy with a second pulse width and a second power level, said second pulse width being greater than said first pulse width and said second power level being higher than said first power level.

3. A proximity integrated circuit card reader according to claim 2 and wherein said first power level is insufficient for reading a proximity integrated circuit card.

4. A proximity integrated circuit card reader according to claim 2 and wherein said first pulse width is insufficient for reading a proximity integrated circuit card.

5. A proximity integrated circuit card reader according to claim 1 and wherein said controller is operative in said card presence sensing mode for causing said transmitter to transmit energy at a first pulse width and is operative in said card reading mode for causing said transmitter to transmit energy at a second pulse width, said second pulse width being greater than said first pulse width.

6. A proximity integrated circuit card reader according to claim 5 and wherein said first pulse width is insufficient for reading a proximity integrated circuit card.

7. A proximity integrated circuit card reader according to claim 1 and wherein said controller is operative in said card presence sensing mode for causing said transmitter to transmit energy at a first power level and is operative in said card reading mode for causing said transmitter to transmit energy at a second power level, said second power level being higher than said first power level.

8. A proximity integrated circuit card reader according to claim 7 and wherein said first power level is insufficient for reading a proximity integrated circuit card.

9. A proximity integrated circuit card reader according to claim 1 and wherein said controller is operative in said card presence sensing mode for causing said transmitter to transmit energy continuously.

10. A proximity integrated circuit card reader according to claim 1 and wherein said controller is operative in said card presence sensing mode in response to a trigger.

11. A point of sale terminal including proximity integrated circuit card reader functionality and comprising:
a transmitter, transmitting energy within a proximity integrated circuit card reading volume;
a receiver, receiving a signal from a proximity integrated circuit card located within said proximity integrated circuit card reading volume; and
a controller operative in a card presence sensing mode for sensing, but not reading, a card located within said proximity integrated circuit card reading volume and, responsive to sensed probable card presence, operative in a card reading mode for reading a card located within said proximity integrated circuit card reading volume.

12. A point of sale terminal including proximity integrated circuit card reader functionality according to claim 11 and wherein said controller is operative in said card presence sensing mode for causing said transmitter to transmit energy at a first pulse width and a first power level and is operative in said card reading mode for causing said transmitter to transmit energy at a second pulse width and a second power level, said second pulse width being greater than said first pulse width and said second power level being higher than said first power level.

13. A point of sale terminal including proximity integrated circuit card reader functionality according to claim 12 and wherein said first power level is insufficient for reading a proximity integrated circuit card.

14. A point of sale terminal including proximity integrated circuit card reader functionality according to claim 12 and wherein said first pulse width is insufficient for reading a proximity integrated circuit card.

15. A point of sale terminal including proximity integrated circuit card reader functionality according to claim 11 and wherein said controller is operative in said card presence sensing mode for causing said transmitter to transmit energy at a first pulse width and is operative in said card reading mode for causing said transmitter to transmit energy at a second pulse width, said second pulse width being greater than said first pulse width.

16. A point of sale terminal including proximity integrated circuit card reader functionality according to claim 15 and wherein said first pulse width is insufficient for reading a proximity integrated circuit card.

17. A point of sale terminal including proximity integrated circuit card reader functionality according to claim 11 and wherein said controller is operative in said card presence sensing mode for causing said transmitter to transmit energy at a first power level and is operative in said card reading mode for causing said transmitter to transmit energy at a second power level, said second power level being higher than said first power level.

18. A point of sale terminal including proximity integrated circuit card reader functionality according to claim 17 and wherein said first power level is insufficient for reading a proximity integrated circuit card.

19. A point of sale terminal including proximity integrated circuit card reader functionality according to claim 11 and wherein said controller is operative in said card presence sensing mode for causing said transmitter to transmit energy continuously.

20. A point of sale terminal including proximity integrated circuit card reader functionality according to claim 11 and wherein said controller is operative in said card presence sensing mode in response to a trigger.
